(19) United States
(12) Patent Application Publication
(10) Pub. No.: US 2005/0114851 A1
(43) Pub. Date: May 26, 2005

(54) System and method for configuring a graphical user interface based on data type

(76) Inventors: Brett Watson-Luke, Indooroopilly (AU); Matthew L. Callanan, Ferny Grove (AU)

Correspondence Address: Schwegman, Lundberg, Woessner & Kluth, P.A., P.O. Box 2938, Minneapolis, MN, 55402, US

(21) Appl. No.: 10/723,243

(22) Filed: Nov. 26, 2003

(51) Int. Cl. G06F 9/44; G06F 17/30; G06F 12/00

(52) U.S. Cl. 717/168; 717/169; 717/170; 707/200; 707/203

(57) ABSTRACT

A system and method for configuring a graphical user interface based on data type are described herein. In one embodiment, the method includes receiving an input through a graphical user interface. The method further includes determining a data type, wherein the data type is associated with a set of configuration items, wherein each of the configuration items is represented in a markup language, and wherein the configuration items correspond to configuration data stored in an operation support system. The method also includes selecting an operation based on the configuration item data type, wherein the operation is associated with the input. The method also includes performing the operation.

### RELATED FILES

This invention is related to the following cofiled, coassigned and copending applications:

Application Ser. No. ______, filed Nov. 26, 2003, entitled “SYSTEMS, METHODS AND SOFTWARE TO CONFIGURE AND SUPPORT A TELECOMMUNICATIONS SYSTEM” (Attorney Docket No.: 500.825US1);
Application Ser. No. ______, filed Nov. 26, 2003, entitled “SYSTEM AND METHOD FOR HIERARCHICALLY REPRESENTING CONFIGURATION ITEMS” (Attorney Docket No.: 500.828US1);
Application Ser. No. ______, filed Nov. 26, 2003, entitled “SYSTEM AND METHOD FOR MANAGING OSS COMPONENT CONFIGURATION” (Attorney Docket No.: 500.827US1);
Application Ser. No. ______, filed Nov. 26, 2003, entitled “BIDIRECTIONAL INTERFACE FOR CONFIGURING OSS COMPONENTS” (Attorney Docket No.: 500.830US1); and
Provisional application Ser. No. ______, filed Nov. 26, 2003, entitled “SYSTEMS, METHODS AND SOFTWARE TO CONFIGURE AND SUPPORT A TELECOMMUNICATIONS SYSTEM” (Attorney Docket No.: 500.831PRV); all of the above which are hereby incorporated by reference.

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### FIELD

This invention relates generally to the field of operational support system software and more particularly to graphical user interfaces used in conjunction with operational support system software.

### BACKGROUND

Telecommunications providers offer a wide variety of products and services to their continuously expanding consumer bases. In order to keep pace with ever-changing products and customer demands, many telecommunications providers employ Operations Support Systems (OSS) to track resource provisioning, convergent billing, customer management information, and other telecommunication-related information. The OSS typically include a number of separate databases for storing the information related to resource provisioning, convergent billing, etc. One disadvantage of some OSS is that several different databases have to be updated when new products and services are offered. For example, when a new wireless Internet plan is offered, both the convergent billing and customer management information databases must be updated. Another disadvantage of many OSS is that some OSS do not offer relatively fast and easy-to-use tools for changing information across numerous OSS databases.

### SUMMARY

A system and method for configuring a graphical user interface based on data type are described herein. In one embodiment, the method includes receiving an input through a graphical user interface. The method further includes determining a data type, wherein the data type is associated with a set of configuration items, wherein each of the configuration items is represented in a markup language, and wherein the configuration items correspond to configuration data stored in an operation support system. The method also includes selecting an operation based on the configuration item data type, wherein the operation is associated with the input. The method also includes performing the operation.

In one embodiment the apparatus includes a data types module to determine a data type, wherein the data type is associated with a set of configuration items, wherein each of the configuration items is represented in a markup language, and wherein the configuration items correspond to configuration data stored in an operation support system. The apparatus also includes a system controller module to receive the data type from the data types module, wherein the system controller module is adapted to select an operation based on the data type, and wherein the system controller is adapted to perform the operation.

### BRIEF DESCRIPTION OF THE FIGURES

The present invention is illustrated by way of example and not limitation in the Figures of the accompanying drawings in which:

FIG. 1 illustrates an exemplary computer system used in conjunction with certain embodiments of the invention;

FIG. 2 is a block diagram illustrating a configuration management system, according to exemplary embodiments of the invention;

FIG. 3 illustrates a configuration tools interface unit, according to exemplary embodiments of the invention;

FIG. 4 is a screenshot of one view of the graphical user interface, according to exemplary embodiments of the invention;

FIG. 5A is a flow diagram illustrating operations for presenting graphical user interface components and processing user selections, according to exemplary embodiments of the invention;

FIG. 5B is a flow diagram illustrating additional operations (the flow diagram continues from the flow of FIG. 5A) for presenting graphical user interface components and processing user selections, according to exemplary embodiments of the invention;

FIG. 6 is a flow diagram illustrating operations (the flow diagram continues from the flow of FIG. 5A) for determining data types associated with configuration items, according to exemplary embodiments of the invention;

FIG. 7 is a screenshot of a graphical user interface used in conjunction with a configurable interactive utility, according to exemplary embodiments of the invention;

FIG. 8 is a flow diagram illustrating operations for creating and/or modifying configuration items with an interactive utility, according to exemplary embodiments of the invention;

FIG. 9 is a screen shot screenshot of a graphical user interface used in conjunction with a configurable interactive utility, according to exemplary embodiments of the invention;

FIG. 10 is a flow diagram illustrating operations for modifying configuration item attributes using property sheets, according to exemplary embodiments of the invention;

FIG. 11 is a flow diagram illustrating operations for implementing a product catalog, according to exemplary embodiments of the invention;

FIG. 12 is a flow diagram illustrating operations for searching for values within a configuration item, according to exemplary embodiments of the invention;

FIG. 13 is a flow diagram illustrating operations for grouping configuration items, according to exemplary vitamins of the invention; and

FIG. 14 is a flow diagram illustrating operations for implementing a taskbar, according to exemplary embodiments of the invention.

### DESCRIPTION OF THE EMBODIMENTS

Systems and methods for configuring a graphical user interface based on data type are described herein. In the following description, numerous specific details are set forth. However, it is understood that embodiments of the invention may be practiced without these specific details. In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Moreover, in this description, the phrase “exemplary embodiment” means that the embodiment being referred to serves as an example or illustration.

Herein, block diagrams illustrate exemplary embodiments of the invention. Also herein, flow diagrams illustrate operations of the exemplary embodiments of the invention. The operations of the flow diagrams will be described with reference to the exemplary embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Moreover, it should be understood that although the flow diagrams depict serial operations, certain embodiments could perform certain of those operations in parallel.

This description of the embodiments is divided into three sections. In the first section, an exemplary computer system and operating environment is described. In the second section, a system level overview is presented. In the third section, an exemplary implementation is described.

### Hardware and Operating Environment

This section provides an overview of the exemplary hardware and the operating environment in which embodiments of the invention can be practiced.

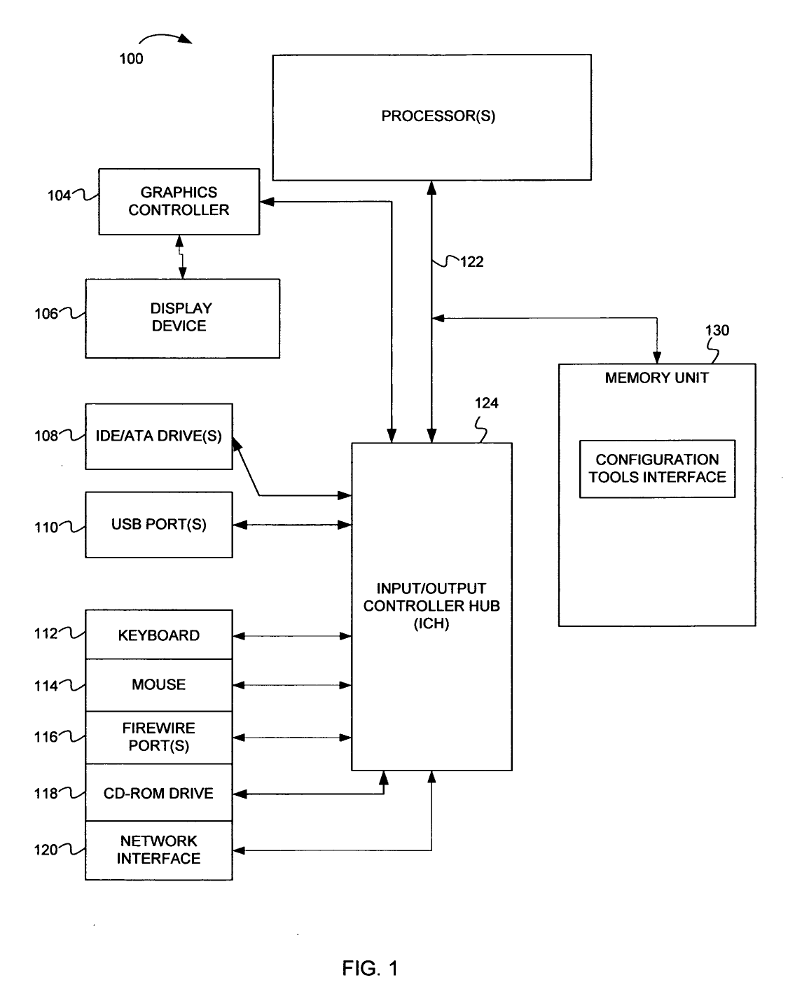

FIG. 1 illustrates an exemplary computer system used in conjunction with certain embodiments of the invention. As illustrated in FIG. 1, computer system 100 comprises processor(s) 102. The computer system 100 also includes a memory unit 130, processor bus 122, and Input/Output controller hub (ICH) 124. The processor(s) 102, memory unit 130, and ICH 124 are coupled to the processor bus 122. The processor(s) 102 may comprise any suitable processor architecture. The computer system 100 may comprise one, two, three, or more processors, any of which may execute a set of instructions in accordance with embodiments of the present invention.

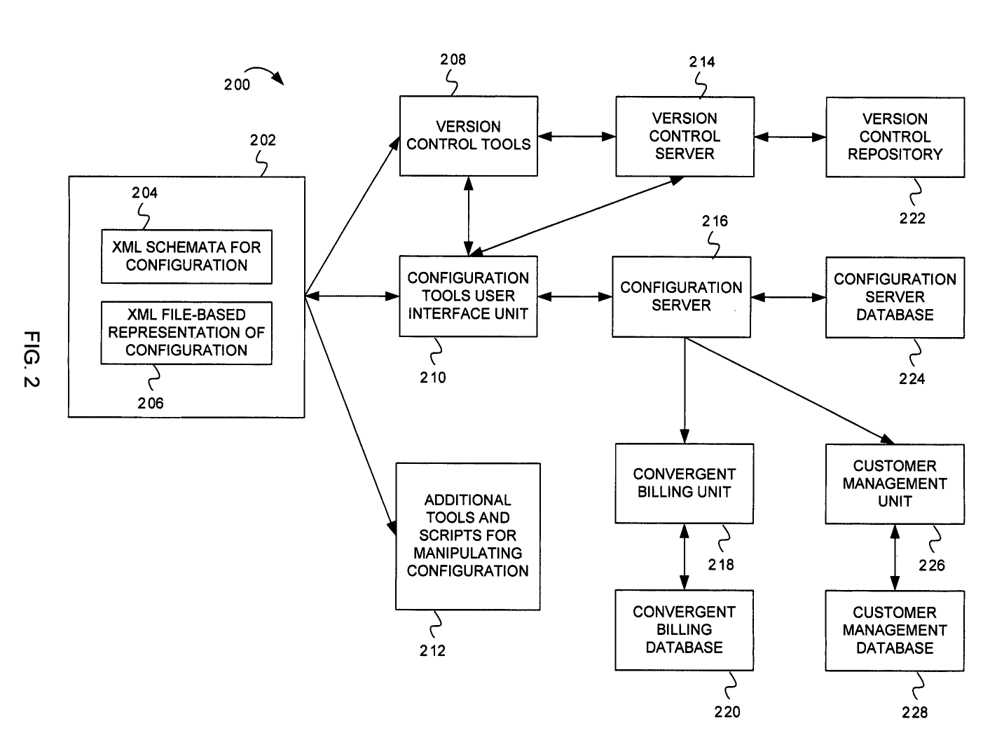

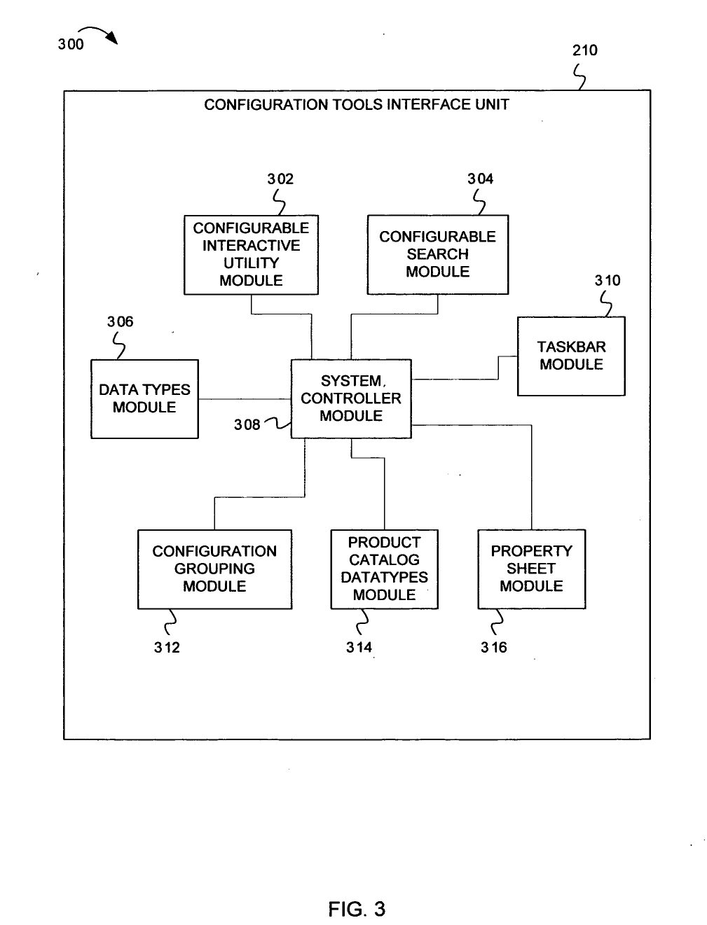

The memory unit 130 includes a configuration tools interface, which is described in greater detail below (see FIGS. 2 and 3). The memory unit 130 stores data and/or instructions, and may comprise any suitable memory, such as a dynamic random access memory (DRAM), for example. The computer system 100 also includes IDE drive(s) 108 and/or other suitable storage devices. A graphics controller 104 controls the display of information on a display device 106, according to embodiments of the invention.

The input/output controller hub (ICH) 124 provides an interface to I/O devices or peripheral components for the computer system 100. The ICH 124 may comprise any suitable interface controller to provide for any suitable communication link to the processor(s) 102, memory unit 130 and/or to any suitable device or component in communication with the ICH 124. For one embodiment of the invention, the ICH 124 provides suitable arbitration and buffering for each interface.

For one embodiment of the invention, the ICH 124 provides an interface to one or more suitable integrated drive electronics (IDE) drives 108, such as a hard disk drive (HDD) or compact disc read only memory (CD ROM) drive, or to suitable universal serial bus (USB) devices through one or more USB ports 110. For one embodiment, the ICH 124 also provides an interface to a keyboard 112, a mouse 114, a CD-ROM drive 118, one or more suitable devices through one or more firewire ports 116. For one embodiment of the invention, the ICH 124 also provides a network interface 120 though which the computer system 100 can communicate with other computers and/or devices. In one embodiment, the computer system 100 includes a machine-readable medium that stores a set of instructions (e.g., software) embodying any one, or all, of the methodologies for configuring a graphical user interface based on data type described herein. Furthermore, software can reside, completely or at least partially, within memory unit 130 and/or within the processor(s) 102.

### System Level Overview

This section provides a system level overview of exemplary embodiments of the invention. FIG. 2 shows a block diagram of a system for scheduling I/O requests. Operations of the functional units of FIG. 2 are described in the following sections.

FIG. 2 is a block diagram illustrating a configuration management system, according to exemplary embodiments of the invention. As shown in FIG. 2, the configuration management system 200 includes an Extensible Markup Language (XML) repository (shown as XML repository 202), which includes an XML schemata 204 for configuration and XML file-based representation of configuration 206. In one embodiment, configuration is a set of one or more configuration items. In one embodiment, configuration items are data that change the operations or behavior of the one or more components of the configuration management system 200. In an alternative embodiment, the configuration items are represented in any suitable fashion (e.g., the configuration items can be represented any suitable markup language). The XML repository 202 is connected to version control tools 208, configuration tools user interface 210, and additional tools and scripts for manipulating configuration 212. The configuration tools user interface 210 is connected to the version control tools 208, a version control server 214, and a configuration server 216. The version control tools 208 is connected with the version control server 214, which is connected to a version control repository 212. The configuration server 216 is connected to a configuration server database 224, a convergent billing unit 218, and a customer management unit 226. The convergent billing unit 218 is connected to a convergent billing database 220, while the customer management unit 226 is connected to a customer management database 228. According to embodiments of the invention, the configuration server 216 can be connected to additional components, such as a provisioning management unit and a provisioning management database. In one embodiment, the additional components can be added after the configuration management system 200 has been deployed in the field.

In the convergent management system 200, the version control tools 208, version control server 214, and version control repository 212 are used for tracking version information associated with configuration stored in the system's various storage units (e.g., the XML repository 202, convergent billing database 220, customer management database 228, etc.). These components include basic tools for committing changes to configuration, viewing differences between configuration versions, and grouping configuration items based on version.

In the configuration management system 200, low-level representations of configuration are stored in the convergent billing database 220 and the customer management database 228. In one embodiment, low-level configuration representations include relational database representations of the configuration. However, other embodiments call of other suitable low-level persistent representations of the configuration. The configuration server 224 and the XML repository 202 store high-level representations (also referred to as file-based representations) of the configuration. The high-level representations of the configuration can be used for querying and updating configuration stored in the various databases (e.g., the convergent billing database 220 and the customer management database 228), as described in greater detail below (see exemplary implementation section). In one embodiment of the invention, the high-level representations of the configuration include XML representations of configuration. In alternative embodiments, the high-level representations include other suitable representations of the configuration (e.g., other markup language representations of the configuration).

The XML schemata 204 define the structure and content of the high-level configuration representation. Various components of the configuration management system 200 (e.g., the configuration tools user interface 210) use information contained within the XML schemata 204 when reading and processing configuration. For example, the configuration tools user interface unit 210 uses the XML schemata 204 and the XML file-based representation of configuration 206 for processing configuration. Additionally, the configuration tools user interface unit 210 presents various user interface components based on the XML schemata 204 and the high-level representations of configuration, as described in greater detail throughout this description.

In one embodiment of the invention, the convergent billing unit 218 and the convergent billing database 220 store and process configuration used in executing a convergent billing system. The customer management unit 226 and the customer management database 228 store and process configuration used in executing a customer management system. In one embodiment, the configuration management system 200 includes an operations support system (OSS). In one embodiment, an operations support system generally refers to a system for performing management, inventory, engineering, planning, and repair functions for communications service providers and their networks.

FIG. 3 illustrates a configuration tools interface unit, according to exemplary embodiments of the invention. As shown in FIG. 3, the configuration tools interface unit 210 includes a system controller module 308. The system controller module 308 is connected to a configurable interactive utility module 302, configurable search module 304, taskbar module 310, property sheet module 316, a product catalog data types module 314, configuration grouping module 312, and a data types module 306. Operations for each of the components shown in FIG. 3 will be described in greater detail below, in the next section. In one embodiment, the configuration tools interface unit 210 is included within the computer system 100. Furthermore, the computer system 100 includes or is communicatively coupled with (directly or indirectly) other components of the configuration management system 200.

According to embodiments of the invention, the components (e.g., the system controller module 308, data types module 306, etc.) of the configuration tools interface unit 210 can be integrated or divided, forming a lesser or greater number of components. According to embodiments, the components can include queues, stacks, and/or other data structures necessary for performing the functionality described herein. Moreover, the components units can be logically/communicatively coupled using any suitable communication method (message passing, parameter passing, signals, etc.). Additionally, the components can be connected according to any suitable interconnection architecture (fully connected, hypercube, etc.). Any of the components used in conjunction with embodiments of the invention can include machine-readable media for performing operations described herein. Machine-readable media includes any mechanism that provides (i.e., stores and/or transmits) information in a form readable by a machine (e.g., a computer). For example, a machine-readable medium includes read only memory (ROM), random access memory (RAM), magnetic disk storage media, optical storage media, flash memory devices, electrical, optical, acoustical or other forms of propagated signals (e.g., carrier waves, infrared signals, digital signals, etc.), etc. According to embodiments of the invention, the functional units can be other types of logic (e.g., digital logic) for executing the operations for configuring a graphical user interface (GUI) described herein.

### Exemplary Implementation

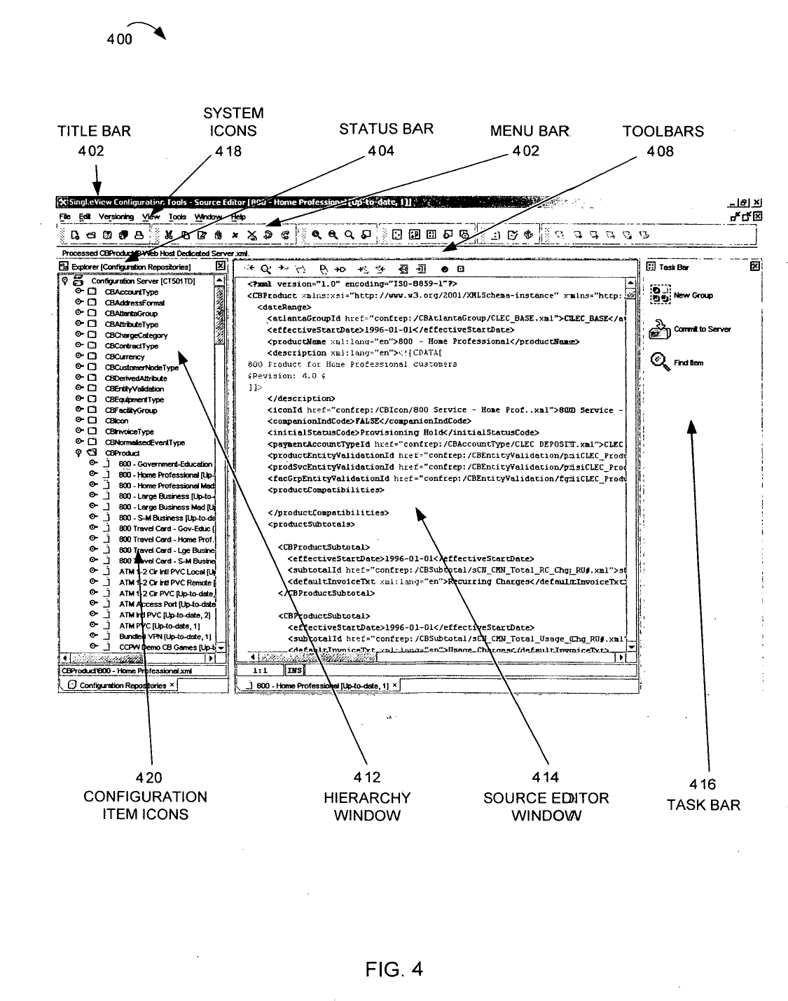

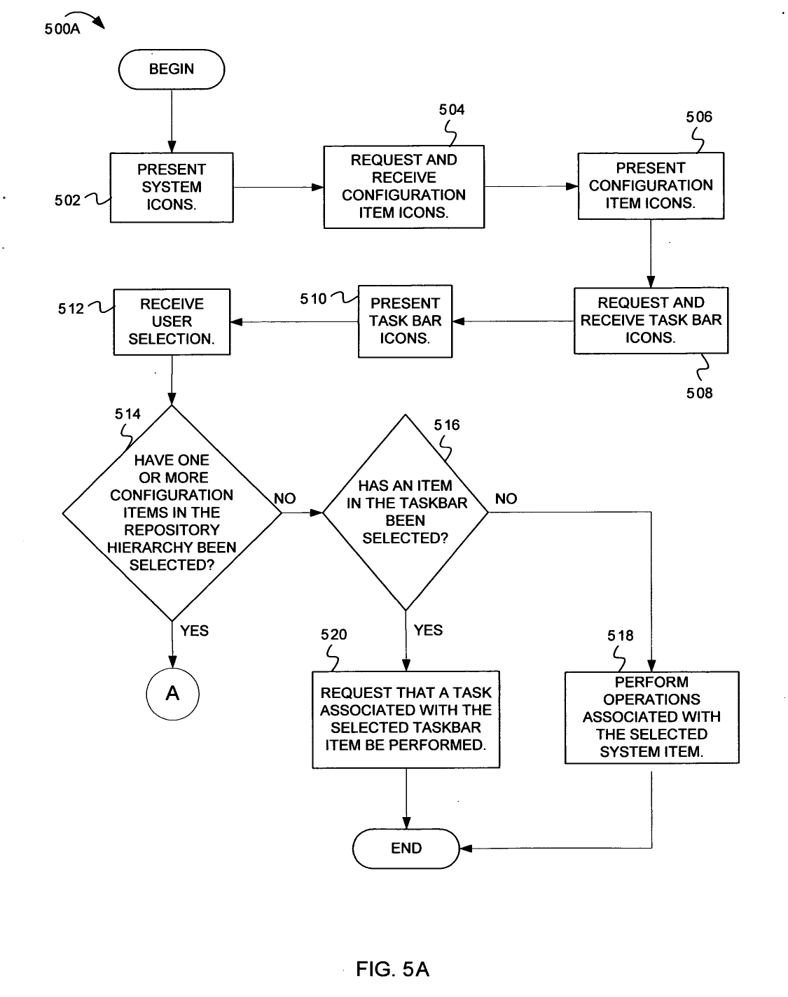

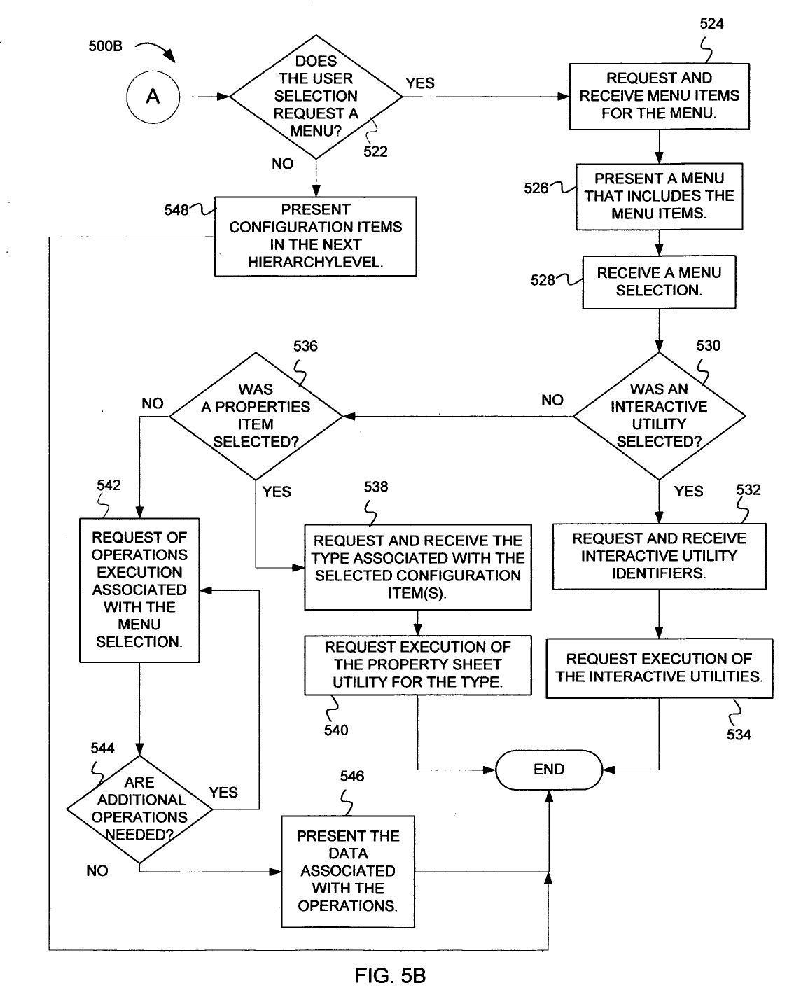

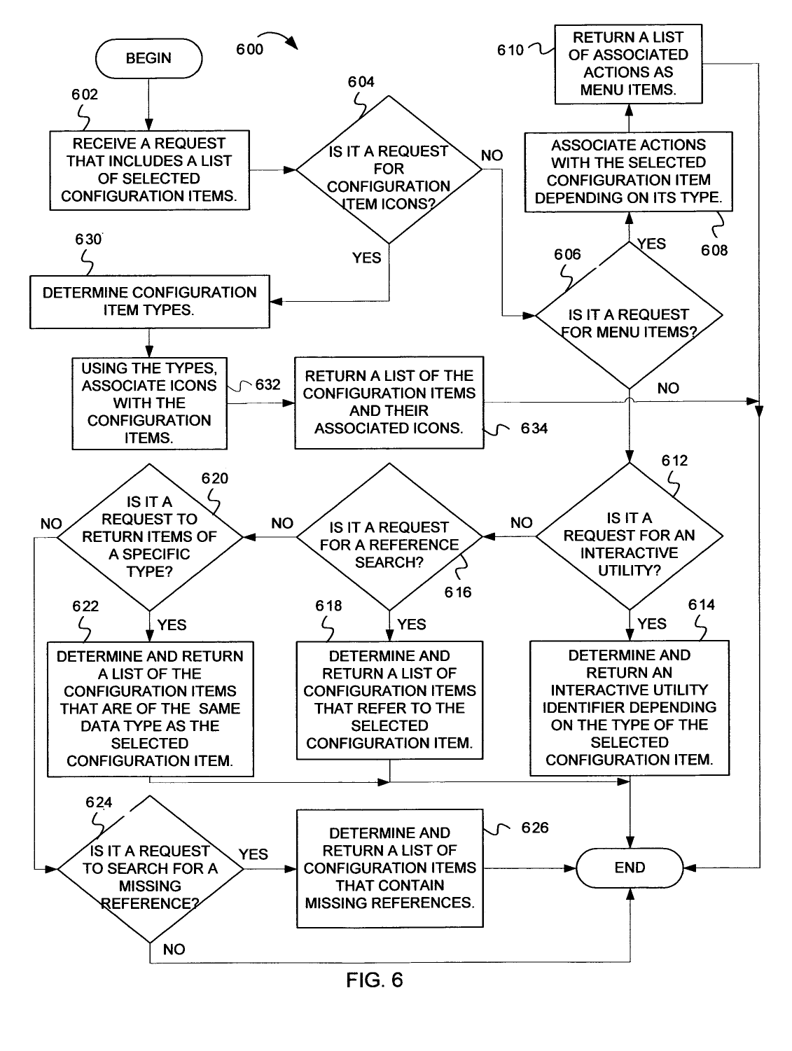

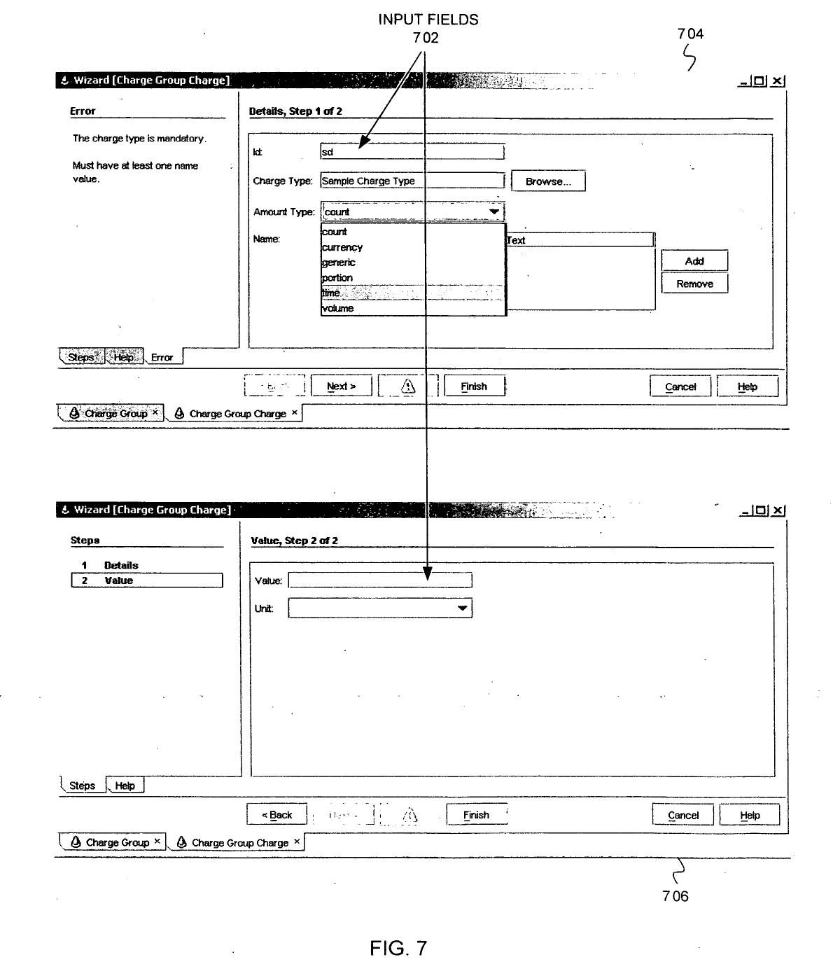

This section describes an exemplary implementation of the invention. In this section, FIGS. 4-14 will be presented. In particular, FIG. 4 shows a screenshot of a GUI, while FIGS. 5-6 describe operations performed by the configuration tools interface unit 210 for presenting components of the GUI. Similarly, FIGS. 7-14 include additional screen shots and operations for presenting components of the GUI.

FIG. 4 is a screenshot of the graphical user interface presented by the graphical tools user interface unit, according to exemplary embodiments of the invention. As shown in FIG. 4, the screenshot includes a set of GUI components 400. The GUI components 400 include a title bar 402, which is located at the top edge of the GUI components 400. The title bar 402 displays an application program name and other application program information. The title bar 402 also includes minimize, maximize, and exit buttons, which are displayed in the upper right corner of the GUI components 400. The GUI components 400 also include a menu bar 402 for displaying names of the available menus. Additionally, the GUI components 400 include system icons 418, toolbars 408, status bar 404, and taskbar 416.

The GUI components 400 also include a hierarchy window 412, which displays a hierarchical view of various configuration items stored within the configuration management system 200. The hierarchy window 412 includes configuration item icons 420. A source editor window 414 is shown adjacent to the hierarchy window 412, while a taskbar 416 a shown adjacent to the source editor window 414.

While FIG. 4 describes a screenshot presented by the configuration tools interface unit 210, FIGS. 5A and 5B describe operations performed by the graphical tools user interface unit 210. Some of the operations described in FIGS. 5A and 5B are performed in the course of presenting the GUI components 400, whereas others of the operations are for processing other GUI-related information. In performing these operations, the system controller module 308 interacts with other modules of the configuration tools interface unit 210. That is, the system controller module 308 requests and receives information from the other configuration tools interface unit modules.

FIG. 5A is a flow diagram illustrating operations for presenting graphical user interface components and processing user selections, according to exemplary embodiments of the invention. The flow diagram 500A will be described with reference to the exemplary configuration tools interface unit 210 of FIG. 3 and the screenshot of FIG. 4. The flow 500 begins at block 502.

At block 502, system icons are presented. For example, the system controller module 308 presents system icons 418. In one embodiment, the system icons 418 include drop-down menus for performing system-supported operations, such as opening files, searching text, etc. The flow continues at block 504.

At block 504, configuration icons are requested and received. For example, the system controller module 308 requests and receives configuration item icons from the data types module 306. In one embodiment, the configuration icons graphically represent configuration items. In one embodiment, prior to executing the system controller module 308, a user selects a set of configuration items to display. For example, a user selects certain configuration repositories to display (e.g., the configuration server database 224). Operations of the data types module 306 will be described in greater detail below, in the discussion of FIG. 6. The flow continues at block 506.

At block 506, configuration item icons are presented. For example, the system controller module 308 presents the configuration item icons as part of its GUI. In FIG. 4, the configuration item icons 420 appear in the hierarchy window 412. The flow continues at block 508.

At block 508, icons for the taskbar are requested and received. For example, the system controller module 308 requests and receives taskbar icons from the taskbar module 310. The flow continues at block 510. As shown in block 510, the taskbar icons are presented. For example, the system controller module 308 presents the taskbar icons. As shown in FIG. 4, the taskbar icons appear on the right side of the GUI components 400. The flow continues at block 512.

At block 512, a user selection is received. For example, the system controller module 308 receives a user selection. In one embodiment, the user selection is represented by a mouse click associated with one of the GUI components 400 (e.g., configuration item icons 420, taskbar 416, etc.). More specifically, the user selection can be represented a right mouse click, left mouse click, or double left mouse click associated with one of the GUI components 400. In alternative embodiments, the user selection can be represented by any other suitable I/O device input (e.g., touchscreen input, trackball input, voice-recognition software input, etc.). The process continues at block 514.

As shown in block 514, it is determined whether one or more configuration items in the repository hierarchy have been selected. For example, the system controller module 308 determines whether one or more of the configuration item icons 420 have been selected. That is, the system controller module 308 determines whether a user has performed a mouse click on one or more of the configuration item icons 420. If one or more configuration items of the repository hierarchy have been selected, the flow continues at “A”. Otherwise, the flow continues at block 516.

At block 516, it is determined whether an item in the taskbar has been selected. For example, the system controller module determines whether one of the taskbar items has been selected. In one embodiment, the system controller module 308 determines whether the user has performed a mouse click on one or more of the taskbar icons 416. If a taskbar item has not been selected, the flow continues at block 518. Otherwise, the flow continues at block 520.

As shown in block 520, it is requested that a task associated with the selected taskbar item be performed. For example, the system controller module 308 requests that the taskbar module 310 performed the task associated with the selected taskbar item. From block 520, the flow ends.

At block 518, operations associated with the selected system icon are performed. For example, the system controller module 308 performed operations associated with the selected system icon. For example, the system controller module 308 performes operations associated with saving files, searching text, etc. From block 518, the flow ends.

FIG. 5B is a flow diagram illustrating additional operations (the flow diagram continues from the flow of FIG. 5A) for presenting graphical user interface components and processing user selections, according to exemplary embodiments of the invention. The flow diagram 500B will be described with reference to the exemplary configuration tools interface unit 210 of FIG. 3 and the screenshot of FIG. 4. The flow 500B flows from “A” to block 522.

At block 522, it is determined whether the user selection requests a menu. For example, the system controller module 308 determines whether the user selection requests a menu. In one embodiment, the system controller module 308 determines whether the user selection requests a menu by determining whether the user selection is a right mouse click. If the user selection requests a menu, the process continues at block 524. Otherwise, the flow continues at block 548.

At block 548, configuration items in the next hierarchy level are presented. For example, the system controller module 308 presents configuration items of the next hierarchy level in the hierarchy window 412. In one embodiment, this operation is performed in response to receiving a left mouse click associated with a configuration item shown in the hierarchy window 412. In alternative embodiment, the system controller module 308 performed this operation in response to other types of user input (e.g., input generated by a touchscreen, trackbal, etc.). From block 548, the flow ends.

At block 524, menu items for the menu are requested and received. For example, the system controller module 308 requests and receives menu items for the menu from the data types module 306. The data types module 306 returns menu items based on the data type of the one or more selected configuration items (see block 514 of FIG. 5A). From block 524, the process continues at block 526.

As shown in block 526, a menu that includes the menu items is presented. For example, the system controller module 308 presents a menu that includes the menu items that were received from the data type module 306. In one embodiment, the menu items include a properties item, interactive utility item, search item, catalog item, and references item. Alternative embodiments include other suitable menu items. The process continues at block 528.

At block 528, a menu selection is received. For example, the system controller module 308 receives a menu selection. In one embodiment, the menu selection is represented by a left mouse click. The process continues at block 530.

As shown in block 530, it is determined whether an interactive utility was selected. For example, the system controller module 308 determines whether an interactive utility item was selected from the menu, which was presented at block 526. If an interactive utility was selected, the process continues at block 532. Otherwise, the process continues at block 536.

At block 532, interactive utility identifiers are requested and received. For example, the system controller module 308 requests and received interactive utility identifiers from the data types module 306. In one embodiment, the interactive utility identifiers are identifiers that indicate one or more interactive utilities that are to be used with the menu selection. In one embodiment, the interactive utilities that are to be used are based on the data type associated with the selected configuration items. The flow continues at block 534.

As shown in block 534, execution of the interactive utilities is requested. For example, the system controller module 308 requests that the configurable interactive utility module 302 execute the interactive utilities. From block 534, the flow ends.

At block 536, it is determined whether a properties item is selected from the menu. For example, the system controller module 308 determines whether a properties item was selected from the menu. If a properties item were selected, the process continues at block 538. Otherwise, the process continues at block 542.

At block 538, a data type associated with the selected configuration item(s) is requested and received. For example, the system controller module 308 requests a type associated with the selected configuration items from the data types module 306. The process continues at block 540.

As shown in block 540, execution of the property sheet utility associated with the data type is requested. For example, the system controller module 308 requests that the property sheet module 316 execute the property sheet utility for the data type associated with the selected configuration item(s). From block 540, the flow ends.

At block 542, a request is made for execution of operations associated with the menu selection. For example, the system controller module 308 requests that another module of the configuration tools interface unit 210 execute operations associated with the menu selection. For example, the system controller module 308 requests that the product catalog data types module 314 perform operations associated with a menu selection. That is, if a product catalog menu item is selected, the system controller module 308 calls the product catalog data types module 314 to perform operations associated with the product catalog menu item. Similarly, the system controller module 308 can call the configuration grouping module 312, configurable interactive utility module 302, data types module 306, etc. to perform operations associated with the menu selection. From block 542, the flow continues at block 544.

As shown in block 544, it is determined whether additional operations are needed. For example, the system controller module 308 determines whether additional modules should be called for performing operations associated with the menu selection. For example, if the data types module 306 were called to determine the data type associated with a selected configuration item, additional modules (e.g., configurable search module 304) could be called to perform operations based on the data type. If additional operations are needed, the process continues at block 542. Otherwise, the process continues at block 546.

At block 546, data associated with the operations is presented. For example, the system controller 308 presents data associated with the operations performed by the various configuration tools interface unit modules. As a more specific example, the system controller 308 presents the results of search operations performed by the configurable search module 304. Alternatively, the results of operations performed by other modules could be presented. From block 546, the flow ends.

In the following discussion of FIG. 6, operations for determining a configuration item's data type will be described. Before discussing those operations, a brief description of data types will be given. In one embodiment of the invention, XML files define attributes of a data type. According to embodiments, the data type definition specifies the following: 1) a display name for the data type; 2) information for recognizing files of the data type, for example, the data type schema; 3) references applicable to the data type; 4) properties of the data type; and 5) properties of the references. According to embodiments, configuration tools interface unit modules use the data type definition for determining a data type associated with selected configuration items. In one embodiment, XPath expressions are used to determine data types. In one embodiment, XPath is a set of Syntax rules for defining different parts of an XML document. The primary purpose of XPath is to address parts of an XML document and to provide basic facilities for manipulating strings, numbers, and Boolean expressions. XPath is also designed so that it has a natural subset that can be used for pattern matching. One example of an XPath expression is:

/*[local-name( ) = ‘category’]/*[local - name ( ) = ‘name’ and
string(.) = ‘Small Business’]

This search will find all configuration items with the “category” element and the “name” element containing “Small Business”.

The following XML code segment is an exemplary definition of the group data type.

Code Segment:

```
<?xml version=“1.0” encoding=“UTF-8”?>
<dt:dataType xmlns:dt=
  “http://www.adc.com/ConfigurationUI/
  DatatypeDefinition”
  xmlns:xsi=“http://www.w3.org/2001/XMLSchema-instance”
  xsi:schemaLocation=
    “http://www.adc.com/ConfigurationUI
    /DatatypeDefinition
    http://www.adc.com/schema/confui/
    datatype.xsd”>
    <dt:displayName xml:lang=“en”>Group</dt:displayName>
    <dt:datatypeGroup xml:lang=“en”>
      Configuration Management
    </dt:datatypeGroup>
    <dt:schema>
      http://www.adc.com/conftool/group/v5.0
    </dt:schema>
    <dt:rootElement>group</dt:rootElement>
    <dt:matchXPath>
      /ctDefault:group[@xsi:type=‘Group’]
    </dt:matchXPath>
    <dt:iconBase>
      com/adc/confui/group/resources/GroupIcon
    </dt:iconBase>
    <dt:idXPath>@id</dt:idXPath>
    <dt:linkType>
      <dt:dataTypeRef>any</dt:dataTypeRef>
      <dt:elementName>member</dt:elementName>
      <dt:xpath>
        /ctDefault:group/ctDefault:members/
        ctDefault:member
      </dt:xpath>
      <dt:parentXpath>
        /ctDefault:group/ctDefault:members
      </dt:parentXpath>
      <dt:propertySet name=“Group Member”>
        <dt:property>
          <dt:xpath>@exportPriority</dt:xpath>
          <dt:displayName>Export Priority</dt:displayName>
          <dt:shortDescription>
            For an exportable item, the priority of the item
            during an export
          </dt:shortDescription>
          <dt:canEdit>true</dt:canEdit>
          <dt:attributeName>
            exportPriority
          </dt:attributeName>
        </dt:property>
      </dt:propertySet>
    </dt:linkType>
    <dt:propertySet name=“Properties”>
      <dt:property>
        <dt:xpath>ctDefault:name</dt:xpath>
        <dt:displayName>Name</dt:displayName>
        <dt:shortDescription>
          Name of the group
        </dt:shortDescription>
        <dt:javaDataType>
          com.adc.confui.datatype.locale.Locale
        </dt:javaDataType>
        <dt:canEdit>true</dt:canEdit>
        <dt:elementName>name</dt:elementName>
      </dt:property>
      <dt:property>
        <dt:xpath>ctDefault:description</dt:xpath>
        <dt:displayName>Description</dt:displayName>
        <dt:shortDescription>
          Description for this group
        </dt:shortDescription>
        <dt:javaDataType>
          com.adc.confui.datatype.locale.Locale
        </dt:javaDataType>
        <dt:canEdit>true</dt:canEdit>
        <dt:previousSiblings>
          <dt:element>name</dt:element>
        </dt:previousSiblings>
        <dt:elementName>description</dt:elementName>
      </dt:property>
      <dt:property>
        <dt:xpath>ctDefault:exportable</dt:xpath>
        <dt:displayName>Exportable?</dt:displayName>
        <dt:shortDescription>
          If true, the contents of this group may be
          exported
        </dt:shortDescription>
        <dt:javaDataType>boolean</dt:javaDataType>
        <dt:canEdit>true</dt:canEdit>
      </dt:property>
    </dt:propertySet>
    <dt:propertySet name=“Attributes”>
      <dt:property>
        <dt:multiple>true</dt:multiple>
        <dt:xpath>
          /ctDefault:group/ctDefault:attributes/
          ctDefault:attribute
        </dt:xpath>
        <dt:valueXpath>.</dt:valueXpath>
        <dt:displayNameXpath>@name</dt:displayNameXpath>
        <dt:shortDescription>Custom attribute for this
          group
        </dt:shortDescription>
        <dt:canEdit>true</dt:canEdit>
      </dt:property>
    </dt:propertySet>
</dt:dataType>
```

The exemplary code segment shown above is one example of a data type definition. According to embodiment of the invention, users can define any number of data types. Some other exemplary sample data types include (data type definitions for the following data types are not shown): 1) CBAccountType—this data type defines account specifications to identify the type of account to which financial transactions are to be applied; and 2) CBAddressFormat—this data type specifies the layout and style of address fields and defines a list of attribute types applied to those fields.

FIG. 6 is a flow diagram illustrating operations for determining data types associated with configuration items, according to exemplary embodiments of the invention. The flow diagram 600 will be described with reference to the exemplary configuration tools interface unit 210 of FIG. 3. The flow begins at block 602.

At block 602, a request that includes a list of selected configuration items is received. For example, the data types module 306 receives a request that includes a list of selected configuration items from the system controller module 308. Additionally, the request includes data types associated with the selected configuration items. The flow continues at block 604.

At block 604, it is determined whether the request is a request for configuration item icons. For example, the data types module 306 determines whether the request is requesting configuration item icons. If configuration item icons are requested, the flow continues at block 630. Otherwise, the flow continues at block 606.

As shown in block 630, configuration item data types are determined. For example, the data types module 306 determines a data type associated with the selected configuration items. In one embodiment, the data types module 306 inspects the high-level XML representation of the configuration items to determine their data type. In an alternative embodiment, the data types module 306 determines a data type associated with the selected configuration items by inspecting low-level representations of the configuration items. From block 630, the flow continues at block 632.

At block 632, based on the configuration item data types, configuration item icons are associated with the configuration items. For example, based on the configuration item data types, the data types module 306 associates icons with the configuration items. The process continues at block 634.

As shown in block 634, a list of the configuration items and their associated icons is returned. For example, the data types module 306 returns a list of the configuration items and their associated icons to the system controller module 308. From block 634, the flow ends.

At block 606, it is determined whether the request is a request for menu items. For example, the data types module 306 determines whether the request is a request for menu items. If the request is a request for menu items, the flow continues at block 608. Otherwise, the process continues at block 612.

As shown in block 608, depending on the data type of the selected configuration item, actions are associated with the selected configuration item. For example, the data types module 306 associates a set of actions with the selected configuration item, depending on its data type. In one embodiment, the actions define operations that the modules of the configuration tools interface unit 210 perform on the selected configuration items. In one embodiment the modules perform the operations in response to receiving menu selections from a user interface. The flow continues at block 610.

At block 610, the list of actions is returned as a list of menu items. For example, the data types module 306 returns a list of menu items to the system controller module 308, where the list of menu items is based on the actions associated with these configuration items. From block 610, the flow ends.

At block 612, it is determined whether the request is a request for an interactive utility. For example, the data types module 306 determines whether the request (received at block 602) is a request for an interactive utility. If the request is a request for an interactive utility, the process continues at block 614. Otherwise, the process continues at block 616.

At block 614, an interactive utility identifier is determined and returned, where the interactive utility identifier is determined based on the data type associated with the selected configuration item. For example, the data types module 306 determines an interactive utility identifier based on the type of the selected configuration item. In one embodiment, the interactive utility identifier identifies an interactive utility that can be called an executed by the system controller module 308 and the configurable interactive utility module 302. In one embodiment, the data types module 306 inspects the high-level XML representation of the configuration items to determine their data type. In an alternative embodiment, the data types module 306 determines data type by inspecting low-level representations of the configuration items. From block 614, the flow ends.

As shown in block 616, it is determined whether the request is a request for a reference search. For example, the data types module 306 determines whether the request is a request for a reference search. If the request is a request for a reference search, the flow continues at block 618. Otherwise, the flow continues at block 620.

At block 618, a list of configuration items that refer to the selected configuration items is determined and returned. For example, the data types module 306 determines and returns a list of configuration items that refer to the selected configuration item. In one embodiment, the data types module 306 inspects the configuration items of selected repositories and determines which of those configuration items refers to the selected configuration items. In one embodiment, the configuration items stored in the selected repositories are represented in XML. In one embodiment, the data types module 306 compares the XML representation of the selected configuration item with the XML representation of other configuration items in the selected repositories. From block 618, the process ends.

At block 620, it is determined whether the request is a request to return items of a specific type. If the request is a request to return items of a specific type, the process continues at block 622. Otherwise, the process continues at block 624.

At block 622, a list of configuration items that are of the same data type as the selected configuration items is determined and returned. For example, the data types module 306 determines and returns a list of configuration items that are of the same data type as the selected configuration items. In one embodiment, the data types module 306 determines this list by inspecting configuration items (which are represented in XML) of selected repositories. In one embodiment, the XML code representing the configuration items is stored in the XML repository 202, while in an alternative embodiment, the XML code is stored in the configuration server database 224. Based on the XML, the data types module 306 determines which of the configuration items stored in the selected repositories are of the same data type as the selected configuration item. From block 622, the flow ends.

At block 624, it is determined whether the request is a request to search for a missing reference. If the request is a request to search for a missing reference, the process continues at block 626. Otherwise, the flow ends.

As shown in block 626, a list of configuration items that contain missing references is determined and returned. For example, the data types module 306 determines and returns a list of configuration items that contain missing references. In one embodiment, the data types module 306 determines this list by inspecting configuration items (which are represented in XML) of selected repositories. Based on the XML, the data types module 306 determines which of the configuration items contain missing references. In one embodiment, the XML representation of each configuration item contains a list of references to other configuration items. The data types module 306 searches for the configuration items recited in the reference list. If the referenced configuration items are not found, they are added to the list. From block 622, the flow ends.

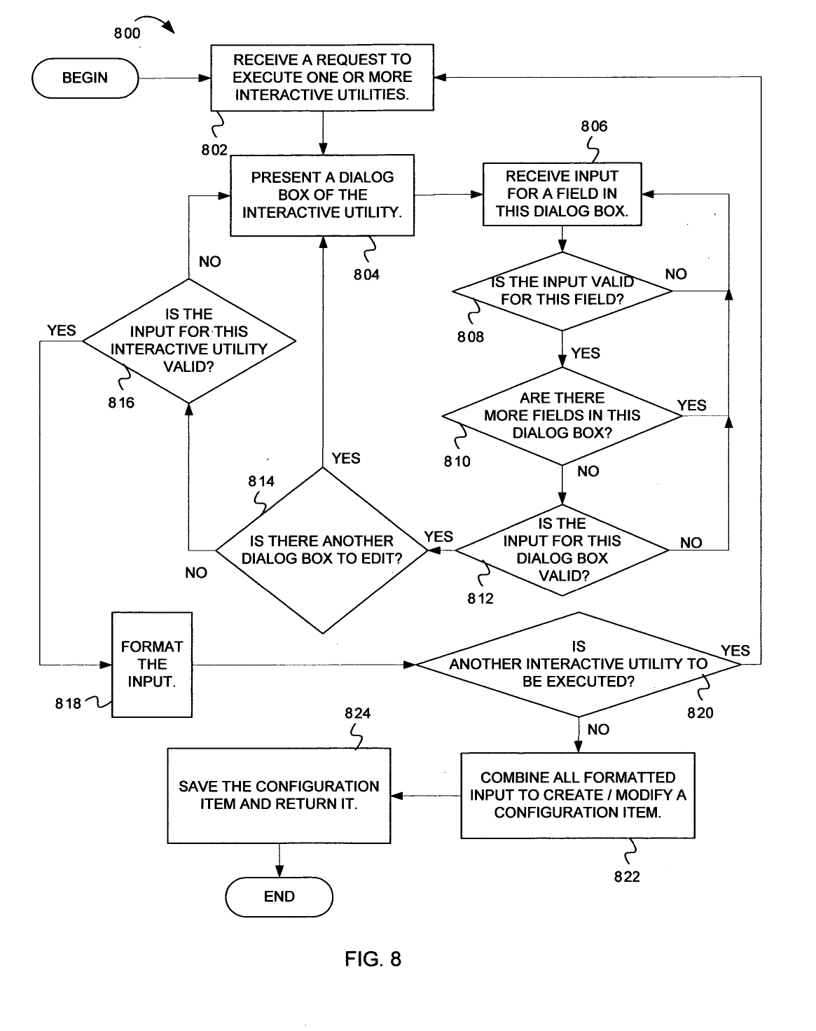

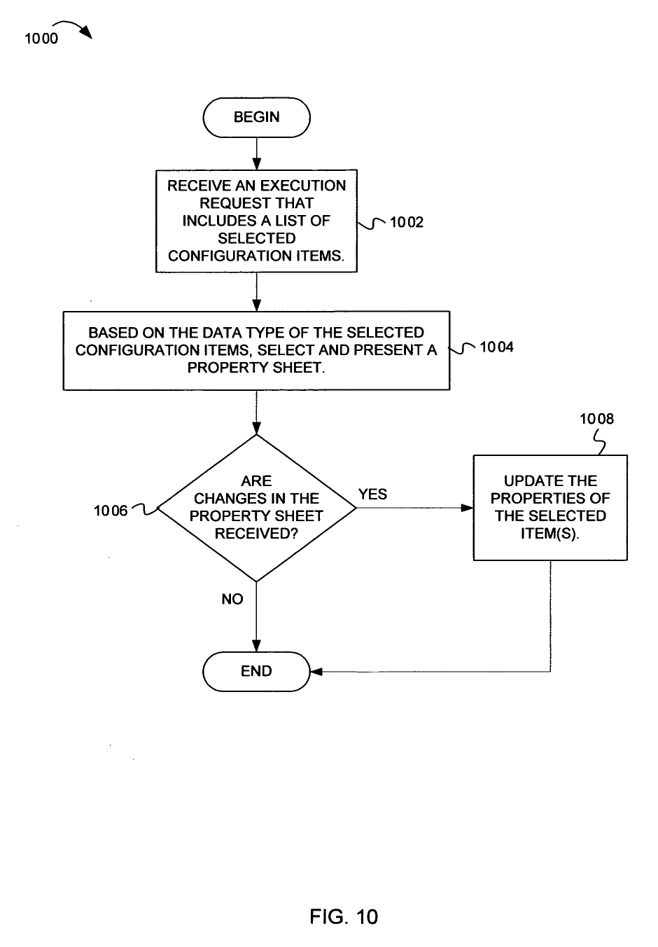

In the discussion of FIGS. 5A-6 above, operations for receiving user input and calling different modules of the configuration tools interface unit 210 were described. Additionally, the discussion above described operations for determining parameters (e.g., menu items, interactive utility identifiers, etc.) based on a data type associated with a selected configuration item. The following discussion of FIGS. 7-14 will describe operations which are performed using the parameters determined in FIGS. 5A-6. For example, FIG. 8 describes operations for executing an interactive utility associated with an interactive utility identifier. As another example, FIG. 10 describes operations for presenting a property sheet based on the data type associated with a selected configuration item.

FIG. 7 is a screenshot of a graphical user interface used in conjunction with a configurable interactive utility, according to exemplary embodiments of the invention. FIG. 7 shows two GUI windows 704 and 706. Each of the windows (704 and 706) include input fields 702 for receiving user input. In one embodiment, the user input includes text. In an alternative embodiment, the user input includes one or more selections from a drop-down menu. Operations performed by the interactive utility are described below, in the description of FIG. 8.

FIG. 8 is a flow diagram illustrating operations for creating and/or modifying configuration items with an interactive utility, according to exemplary embodiments of the invention. The flow diagrams 800 will be described with reference to the exemplary embodiments of FIGS. 3, 5A, 5B, and 7. The flow commences at block 802.

At block 802, a request to execute one or more interactive utilities is received. For example, the configurable interactive utility module 302 receives a request to execute one or more interactive utilities. In one embodiment, the request includes one or more identifiers indicating on particular interactive utilities. The process continues at block 804.

At block 804, a dialog box of the interactive utility is presented. For example, the configurable interactive utility module 302 presents a dialog box of the interactive utility. In one embodiment, as shown in FIG. 7, a dialog box is included in a window. In one embodiment, the dialog box includes input fields (for more details, see input fields 702 of FIG. 7). The flow continues at block 806.

As shown in block 806, input for a field of the dialog box is received. For example, the configurable interactive utility module 302 receives input in a field of the dialog box. In one embodiment, the input is text, while in an alternative embodiment, the input is one or more selections from a drop-down menu. In one embodiment, the input is associated with a value associated with a configuration item. For example, numeric input received from a field can be associated with a configuration item's price value. Alternative embodiments call for other suitable forms of input and value. The flow continues at block 808.

At block 808, it is determined whether the input for the field is valid. For example, the configurable interactive utility module 302 determines whether the input for an input field 720 is valid. In one embodiment, the interactive utility module 302 determines whether the input is within a range of acceptable values for an attribute associated with the field. For example, for a field associated with a time-of-day value, the input must be a valid time-of-day. If the input for the field is not valid, the process continues at block 806. Otherwise, the flow continues at block 810.

As shown in block 810, it is determined whether there are more fields of the dialog box. For example, the configurable interactive utility module 302 determines whether there are more input fields 702 of the dialog box. If there are more fields of the dialog box, the process continues at block 806. Otherwise, the process continues at block 812.

At block 812, it is determined whether the input for the dialog box is valid. For example, the configurable interactive utility module 302 determines whether the input for the dialog box is valid. If the input for the dialog box is valid, the flow continues at block 814. Otherwise the flow continues at block 806.

As shown in block 814, it is determined whether there is another dialog box to edit. For example, the configurable interactive module 302 determines whether there is another dialog box to edit. If there is another dialog box to edit, the process continues at block 804. Otherwise, the process continues at block 816.

At block 816, it is determined whether the input for the interactive utility is valid. For example, the configurable interactive utility module 302 determines whether the input for the interactive utility is valid. If the input is valid, the process continues at block 818. Otherwise, the process continues at block 804. According to alternative embodiments, the configurable interactive utility module 302 performs fewer validity checks. For example, one embodiment, the configurable interactive utility module 302 only determines whether the input for the entire dialog box is valid, thus it does not perform validity checks at the field and dialog box levels.

As shown in block 818, the input is formatted. For example, the configurable interactive utility module 302 formats the input. In one embodiment, the configurable interactive utility module 302 formats the input so that it can be inserted into an XML representation of configuration items. For example, numeric input associated with a configuration item's price value is converted into a format suitable for insertion into an XML representation of the configuration item. The flow continues at block 820.

At block 820, it is determined whether another interactive utility is to be executed. For example, the configurable interactive utility module 302 determines whether another interactive utility is to be executed. If there is another interactive utility to be executed, the process continues at block 802. Otherwise, the process continues at block 822.

At block 822, all formatted input is combined to create/modify a configuration item. For example, the configurable interactive utility module 302 combines all the formatted input (received from the input fields and/or dialog boxes) to create/modify a configuration item. The process continues at block 824.

As shown in block 824, the new/modified configuration item is saved and returned. For example, the configurable interactive utility module 302 saves the new/modified configuration item to its designated repository and returns the configuration item to the calling module (e.g., the system controller module 308). In one embodiment, saving the configuration item includes inserting the combined formatted input into an XML representation of the configuration item and storing the configuration item in the appropriate repository. In one embodiment, the modified/new configuration item is saved in high-level and low-level representations. That is, for example, the modified/new configuration item is saved to the XML repository 202 and the convergent billing database 220.

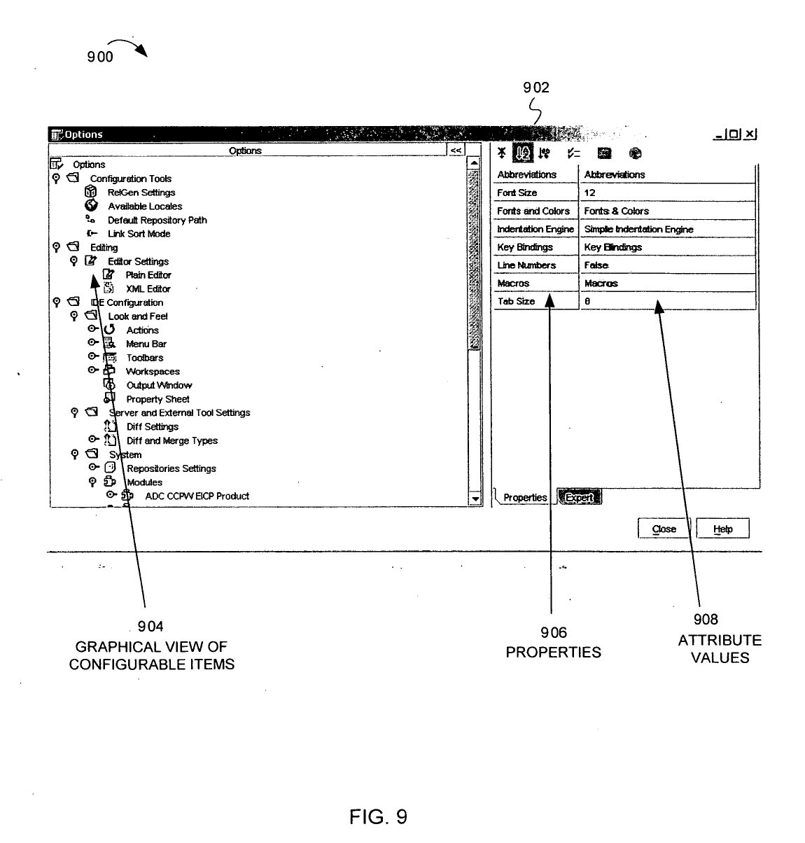

While FIGS. 7 and 8 describe a screen shot and operations for a configurable interactive utility module, FIGS. 9 and 10 describe a screen shot and operations for the property sheet module 316.

FIG. 9 is a screenshot of a graphical user interface used in conjunction with a property sheet, according to exemplary embodiments of the invention. As shown in FIG. 9, the screen shot 900 includes a window 902. The window 902 includes a graphical view of configurable items 904, properties 906, and property values 908. In one embodiment, the configurable items 904 include configuration items. As shown in FIG. 9, the properties 906 and property values 908 are represented in a grid. In the grid, the properties 906 appear in one column and the property values 908 appear in another column. In one embodiment, a user can modify the property values 908. For example, a user can change the property values 908 by inputting text and/or selecting menu options. In one embodiment, when a configurable item 904 is selected, the configurable item's properties 906 and property values 908 are shown in the grid. Operations for modifying properties and property values are described in greater detail below, in the discussion of FIG. 10.

FIG. 10 is a flow diagram illustrating operations for modifying configuration item property values using property sheets, according to exemplary embodiments of the invention. The flow diagram 1000 will be described with reference to the exemplary embodiments shown in FIGS. 3 and 9. The flow diagram 1000 commences at block 1002.

At block 1002, an execution request that includes a list of selected configuration items is received. For example, the property sheet module 316 receives an execution requests that includes a list of selected configuration items from the system controller module 308. The flow continues at block 1004.

At block 1004, based on the configuration items' data type, a property sheet is selected and presented. For example, the property sheet module 316 selects a property sheet based on the selected configuration items' data type. The property sheet module 316 also presents the property sheet. In one embodiment, the property sheet module 316 inspects the high-level XML representation of the configuration items to determine their data type. In an alternative embodiment, the property sheet module 316 determines data type by inspecting low-level representations of the configuration items. As shown in FIG. 9, a property sheet is a grid including properties 906 and property values 908. As noted above, users can modify the property values 908. The flow continues at block 1006.

At block 1006, it is determined whether changes in the property sheet are received. For example, the property sheet module 316 determines whether it has received modifications to the property values of the property sheet. In one embodiment, the property sheet module 316 determines whether a user has modified any of the property values. If no changes are received, the process ends. Otherwise, the process continues at block 1008.

As shown in block 1008, the properties of the selected configuration items are updated. For example, the property sheet module 316 updates the property values to reflect the received changes. In one embodiment, the property sheet module 316 updates the configuration items by modifying portions of the XML representation of the configuration items (stored in the XML repository 202). In an alternative embodiment, the property sheet module 316 updates the configuration items by modifying portions of the low-level representation of the configuration items (stored in the convergent billing database 220 or customer management database 228). From block 1008, the flow ends.

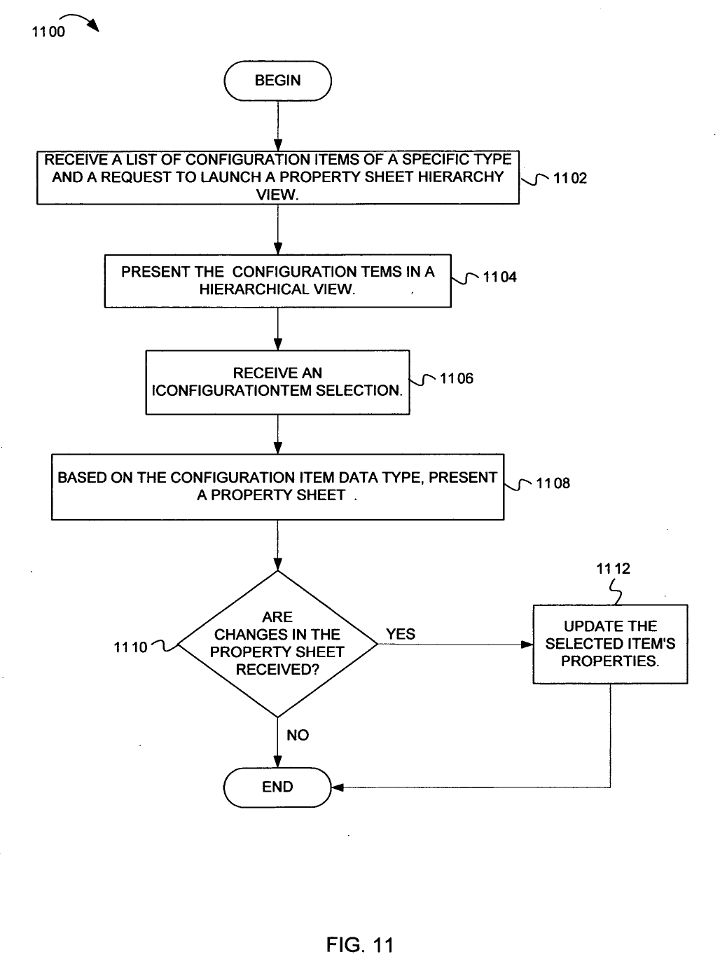

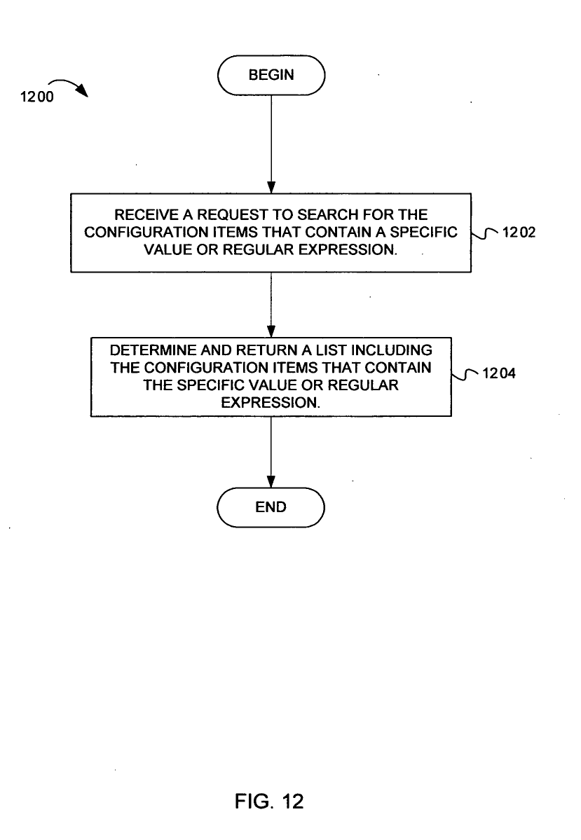

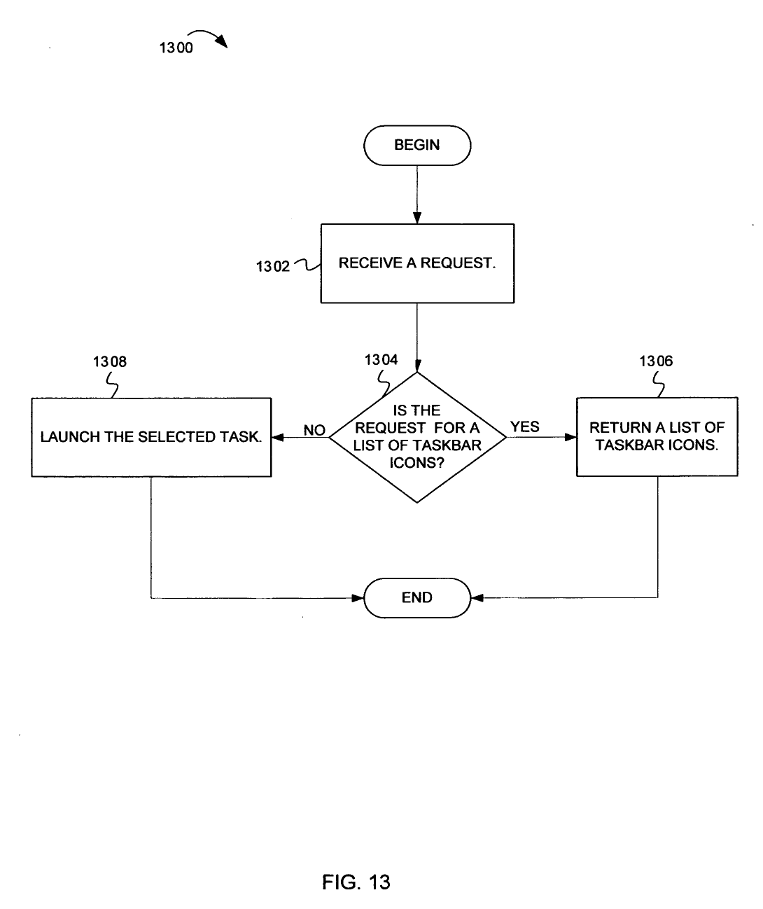

In the following discussion of FIGS. 11-14, additional flow diagrams will be presented. In particular, FIG. 11 describes operations for executing a product catalog, while FIG. 12 describes operations for searching for configuration items that contain a particular value or regular expression. Additionally, FIG. 13 describes operations for grouping configuration items, and FIG. 15 describes operations for implementing a taskbar.

FIG. 11 is a flow diagram illustrating operations for implementing a product catalog, according to exemplary embodiments of the invention. The flow diagram 1100 will be described with reference to exemplary embodiments shown in FIG. 3. The flow diagram 1100 commences at block 1102.

At block 1102, a list of configuration items of a specific data type and a requests to launch a property sheet hierarchy view are received. For example, the product catalog data types module 314 receives a list of items of a specific data type. The product catalog data types module 314 also receives a request to launch a property sheet hierarchy view (see hierarchy window of FIG. 4 for more details about the hierarchy view). The flow continues at block 1104.

As shown in block 1104, the configuration items are presented in a hierarchy view. For example, the product catalog data types module 314 presents the configuration items in a hierarchy view. In one embodiment, the hierarchy view is shown in the hierarchy window 412 of FIG. 4. The flow continues at block 1106.

As shown in block 1106, a configuration item selection is received. For example, the product catalog data types module 314 receives a configuration item selection. In one embodiment, a configuration item selection is received when a user selects (e.g., using a mouse) a configuration item shown in the hierarchy view. The flow continues at block 1108.

As shown in block 1108, based on the configuration item data type, the property sheet is presented. For example, the product catalog data types module 314 presents a property sheet based on the data type associated with the selected configuration item. As described above, in one embodiment, the property sheet includes properties and property values. The property values can be modified by a user (see the description of property sheets above). Because the property sheet is based on the data type associated with the selected configuration item, the product catalog data types module 314 can present different property sheets for different data types. The process continues at block 1110.

At block 1110, is determined whether changes in the property sheet have been received. For example, the product catalog data types module 314 determines whether it has received modifications to the property values of the property sheet. In one embodiment, the product catalog data types module 314 determines whether a user has modified any of the property values through a GUI. If no changes are received, the process ends. Otherwise, the process continues at block 1112.

As shown in block 1112, the properties of the selected configuration items are updated. For example, the product catalog module 314 updates the property values to reflect the received changes. In one embodiment, the product catalog module 314 updates the configuration items by modifying portions of the XML representation of the configuration items (stored in the XML repository 202). In an alternative embodiment, the product catalog module 314 updates the configuration items by modifying portions of the low-level representation of the configuration items (stored in the convergent billing database 220 or customer management database 228). From block 1112, the flow ends.

FIG. 12 is a flow diagram illustrating operations for searching for values within a configuration item, according to exemplary embodiments of the invention. The flow diagram 1200 will be described with reference to the exemplary embodiments shown in FIGS. 3 and 4. The flow diagram 1200 commences at block 1202.

At block 1202, a request to search for configuration items that contain a specific value or regular expression is received. For example, the configurable search module 304 receives a request to search for configuration items that contain a specific value or regular expression. In one embodiment, a regular expression is a set of characters that is defined by a set of symbols and rules. In one embodiment the specific value is a property value, as described above. The flow continues at block 1204.

At block 1204, a list of the configuration items that contain a specific value or regular depression is determined and returned. For example, the configurable search module 304 determines and returns a list of configuration items that contain a specific value or regular expression. In one embodiment, the configurable search module 304 searches through the configuration stored in selected repositories for configuration items containing a specific value or regular expression. For example, the configurable search module 304 searches through configuration items stored in the XML repository 202 for ones containing a specific value or regular expression. Alternatively, the configurable search module 304 searches through multiple repositories (e.g., the configuration server database 220, convergent billing database 224, and the customer management database 228) for configuration items containing a specific value or regular expression. From block 1204, the flow ends.

FIG. 13 is a flow diagram illustrating operations for grouping configuration items, according to exemplary vitamins of the invention. Flow diagram 1300 will be described with reference to the exemplary embodiments of FIGS. 2 and 3. The flow diagram 1300 commences at block 1302.

At block 1302, an execution request is received. For example, configurable grouping module 312 receives and execution request. The process continues at block 1304.

As shown block 1304, it is determined whether the request is a request to return a group of configuration items. For example, the configurable grouping module 312 determines whether the request is a request to return a group of configuration items. If the request is to return a group of configuration items, the process continues at block 1306. Otherwise, the process continues at block 1308.

At block 1306, a list of all configuration items in the selected group is determined and returned. For example, the configurable grouping module 312 determines and returns a list of configuration items in the selected group. In one embodiment, the selected group is a data type. In one embodiment, the configuration grouping module 312 inspects XML representations of the configuration items to determine their data type. From block 1306, the flow ends.

At block 1308, it is determined whether the request is a request to return configuration items referenced by group. For example, the configurable grouping module 312 determines whether the request is a request to return configuration items referenced by group. In one embodiment, the group includes a number of selected configuration items. If the request is a request to return configuration items referenced by group, the process continues at block 1310. Otherwise, the process continues at block 1312.

At block 1310, a list of all configuration items referenced by the group is determined and presented. For example, the configuration grouping module 312 determines and presents of a list of all configuration items referenced by the group. In one embodiment, the configuration grouping module 312 inspects XML representations of the configuration items to determine whether they reference other configuration items. From block 1310, the flow ends.

At block 1312, it is determined whether a request is requesting to add or remove configuration items from a group. For example, the configuration grouping module 312 determines whether a request is requesting to add or remove configuration items from a group. If the request is requesting to add or remove configuration items from a group, the process continues at block 1314. Otherwise, the process continues at block 1316.

As shown block 1314, selected configuration items are added or remove from the group. For example, the configuration grouping module 312 adds or removes selected configuration items to/from the group. In one embodiment, when configuration items are added or removed from a group, the group is graphically presented with the configuration items added or removed. In one embodiment, when configuration items are added to a group, the configuration grouping module 312 modifies high-level and/or low-level representations of the configuration items to indicate new group associations. From block 1314, the flow ends.

At block 1316, is determined whether the request is to create a group. For example, the configuration grouping module 312 determines whether the request is to create a group. If the request is to create a group, the process continues at block 1318. Otherwise, the process continues at block 1320.

At block 1318, the selected group is created and presented. For example, the configuration grouping module 312 creates and presents the selected group. In one embodiment, the configuration grouping module 312 creates groups by modifying XML code representations of the configuration items to indicate group association. After creating the group, the configuration grouping module 312 graphically presents the group. From block 1318, the flow ends.

At block 1320, is determined whether the request is a request to find groups containing specific data. For example, configuration grouping module 312 determines whether the request is a request to find groups containing specific data. In one embodiment, the specific data includes alphanumeric symbols. In an alternative embodiment, the specific data includes binary data. If the request is a request to find groups containing specific data, the flow continues at block 1322. Otherwise, the flow ends.

At block 1322, a list of the groups containing the specified data are determined and presented. For example, the configuration grouping module 312 determines a list of groups that contain specified data. In one embodiment, the configuration grouping module 312 searches through the XML representations of the group's configuration items to determine whether the configuration items contained specified data. From block 1322, the flow ends.

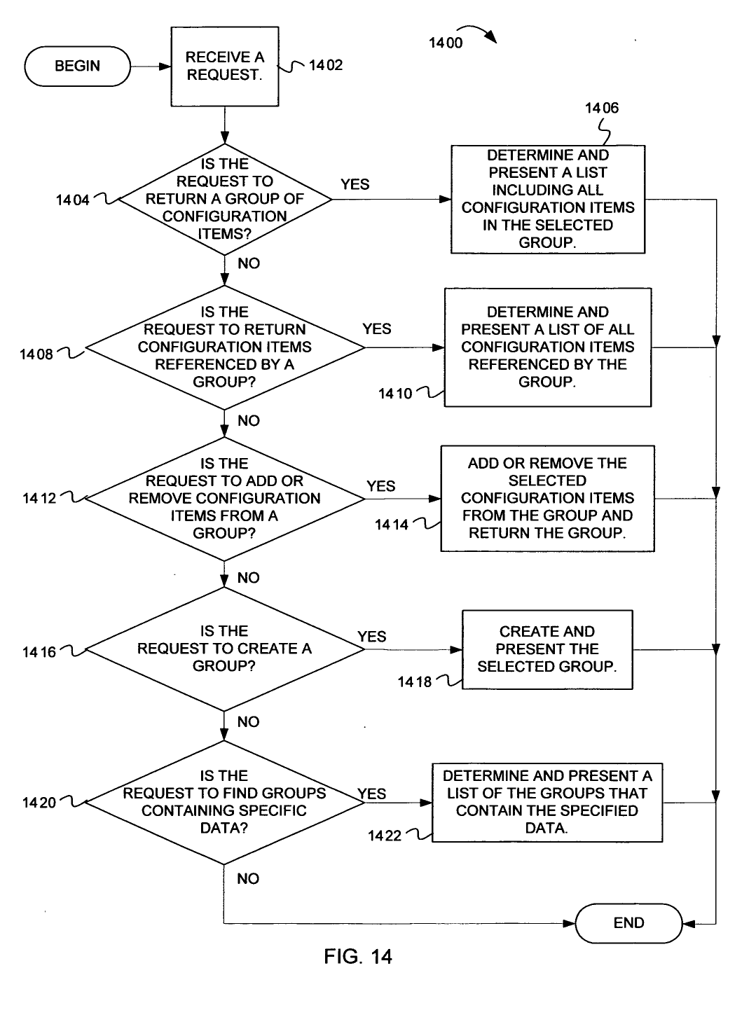

FIG. 14 is a flow diagram illustrating operations for implementing a taskbar, according to exemplary embodiments of the invention. The flow diagram 1400 will be described with reference to the exemplary embodiments shown in FIG. 3. Flow diagram 1400 commences at block 1402.

At block 1402, a request is received. For example, the taskbar module 310 receives a request. In one embodiment, the request includes a task selection. In one embodiment, the request is requesting a list of taskbar icons. The process continues at block 1404.

As shown in block 1404, it is determined whether the request is requesting a list of taskbar icons. For example, the taskbar module 310 determines whether the request is requesting a list of taskbar icons. If the request is a request for taskbar icons, the process continues at block 1406. Otherwise, the process continues at block 1408.

At block 1406, a list of taskbar icons is returned. For example, the taskbar module 310 returns a list of taskbar icons. From block 1406, the flow ends.

At block 1408, a selected task is launched. For example, the taskbar module 310 launches a selected task. In one embodiment, the taskbar calls other modules of the configuration tool interface unit 210 to lunch and perform a selected task. From block 1408, the flow ends.

Thus, a system and method for configuring a graphical user interface based on data type have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

1. A method comprising:
receiving an input through a graphical user interface;
determining a data type, wherein the data type is associated with a set of configuration items, wherein each of the configuration items is represented in a markup language, and wherein the configuration items correspond to configuration data stored in an operation support system;
selecting an operation based on the configuration item data type, wherein the operation is associated with the input; and
performing the operation.

2. The method of claim 1, wherein the each of the configuration items is stored in a separate configuration item file.

3. The method of claim 2, wherein the determining the data type is based on content of the at least one of the separate configuration item files, and wherein the determining is based on a markup language schema or an XPath expression.

4. The method of claim 1, wherein the data type is associated with a data type definition, wherein the data type definition is one of a user-extendable set of data type definitions.

5. The method of claim 4, wherein the data type definition is represented in a markup language.

6. The method of claim 1, wherein the operation is one of a user-extendable set of operations associated with the data type.

7. A method comprising:
receiving a selection of a configuration item, wherein the configuration item is associated with a data type, and wherein the configuration item is represented in a markup language;
selecting a first set of one or more operations from a second set of operations, wherein the selecting is based on the data type;
presenting the first set of one or more operations;
receiving a selection of an operation of the first set the one or more operations; and
performing the operation.

8. The method of claim 7, wherein the configuration item is stored in an operations support system.

9. The method of claim 7, wherein the each of the configuration items is stored in a separate configuration item file.

10. The method of claim 7, wherein the data type is associated with a data type definition, wherein the data type definition is one of a user-extendable set of data type definitions.

11. The method of claim 10, wherein the data type definition is represented in a markup language.

12. The method of claim 7, wherein the first set of operations is a user-extendable set.

13. A method comprising:
executing an interactive utility that is associated with a configuration item data type, wherein the executing includes,
displaying a dialog box, wherein the dialog box includes one or more input fields;
receiving data in one or more of the inputs fields; and
inserting the data into a markup language representation of a configuration item, wherein the configuration item is of the configuration item data type.

14. The method of claim 13, wherein the interactive utility is on of a user-extendable set of interactive utilities.

15. The method of claim 13, wherein the configuration item data type is associated with a plurality of interactive utilities.

16. A method comprising:
determining a data type associated with one or more configuration items, wherein the one or more configuration items include a fist set of property values, and wherein the one or more configuration items are associated with configuration data stored in an operations support system;
determining a second set of properties, wherein ones of the second set of properties are associated with the data type, and wherein ones of the second set of properties correspond with ones of the first set of property values;
presenting a property sheet, wherein the property sheet includes certain ones of the set of properties, and wherein the property sheet includes input fields associated with certain ones of the first set of property values;
receiving data in the input fields; and
modifying ones of the first set of property values based on the data.

17. The method of claim 16, wherein the second set of properties is a user-extendable set.

18. The method of claim 16, wherein the data type is associated with a data type definition, wherein the data type definition is one of a user-extendable set of data type definitions.

19. The method of claim 18, wherein the data type definition is represented in a markup language.

20. An apparatus comprising:
a data types module to determine a data type, wherein the data type is associated with a set of configuration items, wherein each of the configuration items is represented in a markup language, and wherein the configuration items correspond to configuration data stored in an operation support system;
a system controller module to receive the data type from the data types module, wherein the system controller module is adapted to select an operation based on the data type, and wherein the system controller is adapted to perform the operation.

21. The apparatus of claim 20, wherein the each of the configuration items is stored in a separate configuration item file.

22. The apparatus of claim 21, wherein the determination of the data type is based on content of the at least one of the separate configuration item files, and wherein the determination of the data type is based on a markup language schema or an XPath expression.

23. The apparatus of claim 20, wherein the data type is associated with a data type definition, wherein the data type definition is one of a user-extendable set of data type definitions.

24. The apparaus of claim 23, wherein the data type definition is represented in a Extensible Markup Language.

25. A machine-readable medium that provides instructions, which when executed by a machine, cause the machine to perform operations comprising:
receiving an input through a graphical user interface;
determining a data type, wherein the data type is associated with a set of configuration items, wherein each of the configuration items is represented in a markup language, and wherein the configuration items correspond to configuration data stored in an operation support system;
selecting an operation based on the configuration item data type, wherein the operation is associated with the input; and
performing the operation.

26. The machine-readable medium of claim 25, wherein the each of the configuration items is stored in a separate configuration item file.

27. The machine-readable medium of claim 26, wherein the determining the data type is based on content of the at least one of the separate configuration item files, and wherein the determining is based on a markup language schema or an XPath expression.

28. The machine-readable medium of claim 25, wherein the data type is associated with a data type definition, wherein the data type definition is one of a user-extendable set of data type definitions.

29. The machine-readable medium of claim 28, wherein the data type definition is represented in a markup language.

30. The machine-readable medium of claim 25, wherein the operation is one of a user-extendable set of operations associated with the data type.

31. A machine-readable medium that provides instructions, which when executed by a machine, cause the machine to perform operations comprising:
receiving a selection of a configuration item, wherein the configuration item is associated with a data type, and wherein the configuration item is represented in a markup language;
selecting a first set of one or more operations from a second set of operations, wherein the selecting is based on the data type;
presenting the first set of one or more operations;
receiving a selection of an operation of the first set the one or more operations; and
performing the operation.

32. The machine-readable medium of claim 31, wherein the configuration item is stored in an operations support system.

33. The machine-readable medium of claim 31, wherein the each of the configuration items is stored in a separate configuration item file.

34. The machine-readable medium of claim 31, wherein the data type is associated with a data type definition, wherein the data type definition is one of a user-extendable set of data type definitions.

35. The machine-readable medium of claim 34, wherein the data type definition is represented in a markup language.

36. The machine-readable medium of claim 31, wherein the first set of operations is a user-extendable set.

37. A machine-readable medium that provides instructions, which when executed by a machine, cause the machine to perform operations comprising:
executing an interactive utility that is associated with a configuration item data type, wherein the executing includes,
displaying a dialog box, wherein the dialog box includes one or more input fields;
receiving data in one or more of the inputs fields; and
inserting the data into a markup language representation of a configuration item, wherein the configuration item is of the configuration item data type.

38. The machine-readable medium of claim 37, wherein the interactive utility is on of a user-extendable set of interactive utilities.

39. The machine-readable medium of claim 37, wherein the configuration item data type is associated with a plurality of interactive utilities.

40. A machine-readable medium that provides instructions, which when executed by a machine, cause the machine to perform operations comprising:
determining a data type associated with one or more configuration items, wherein the one or more configuration items include a fist set of attributes, and wherein the one or more configuration items are associated with configuration data stored in an operations support system;
determining a second set of properties, wherein ones of the second set of properties are associated with the data type, and wherein ones of the second set of properties correspond with ones of the first set of attributes;
presenting a property sheet, wherein the property sheet includes certain ones of the set of properties, and wherein the property sheet includes input fields associated with certain ones of the first set of attributes;
receiving data in the input fields; and
modifying ones of the first set of attributes based on the data.

41. The machine-readable medium of claim 40, wherein the second set of properties is a user-extendable set.

42. The machine-readable medium of claim 40, wherein the data type is associated with a data type definition, wherein the data type definition is one of a user-extendable set of data type definitions.

43. The machine-readable medium of claim 42, wherein the data type definition is represented in a markup language.
